(19) United States
(12) Patent Application Publication
(10) Pub. No.: US 2017/0142549 A1
(43) Pub. Date: May 18, 2017

(54) SYSTEM AND METHOD FOR TRACKING ITEMS WITHIN A DEFINED AREA

(71) Applicant: TrackR, Inc., Santa Barbara, CA (US)

(72) Inventors: Christopher Herbert, Carlsbad, CA (US); Tsubasa Furukawa, Fountain Valley, CA (US); Christian Smith, Santa Barbara CA, CA (US); Avinash Kunaparaju, San Francisco, CA (US)

(21) Appl. No.: 15/344,139

(22) Filed: Nov. 4, 2016

Related U.S. Application Data
(60) Provisional application No. 62/254,671, filed on Nov. 12, 2015.

(51) Int. Cl. H04W 4/02; H04W 4/12; H04W 48/16

(52) U.S. Cl. CPC H04W 4/021; H04W 48/16; H04W 4/12; H04W 84/12

(57) ABSTRACT

Methods and system for the use of wireless tags, associated or attached to items to be tracked may be provided for the detection of wireless tags by wireless bridges. The wireless bridges may provide a gateway between the wireless tags and a broader network, including local networks such as home/office WI-FI, the Internet, or the Internet via WI-FI or other local network. The wireless bridges may detect the presence of wireless tags within detection range and communicate the presence of wireless tags, the wireless tag identity, as well as wireless bridge location to a user device with access to the network, thus providing location information about the item associated with a particular tag to a user.

### CROSS-REFERENCE TO RELATED APPLICATIONS

This application claims the benefit of priority to U.S. Provisional Application Ser. No. 62/254,671, filed Nov. 12, 2015, the contents of which are incorporated by reference in their entirety.

### BACKGROUND

Field

The disclosure relates generally to the detection and tracking of items associated with wireless tags and, more particularly, to the tracking of such items within a defined area.

Description of Related Art

Low cost tracking devices, which communicate wirelessly with Personal Electronic Devices, or user devices in general, are becoming increasingly common. Such tracking devices will benefit from more sophisticated approaches to determining location and other information relative to tracking device use.

### SUMMARY

Example embodiments described herein have innovative features, no single one of which is indispensable or solely responsible for their desirable attributes. Without limiting the scope of the claims, some of the advantageous features will now be summarized.

In some embodiments, methods and system for the use of wireless tags, associated or attached to items to be tracked may be provided for the detection of wireless tags by wireless bridges. The wireless bridges may provide a gateway between the wireless tags and a broader network, including local networks such as home/office WI-FI, the Internet, or the Internet via WI-FI or other local network. The wireless bridges may detect the presence of wireless tags within detection range and communicate the presence of wireless tags, the wireless tag identity, as well as wireless bridge location to a user device with access to the network, thus providing location information about the item associated with a particular tag to a user.

In a first aspect, a method may be provided for assigning a wireless bridge location information; detecting wireless tags within range by the wireless bridge; and communicating information including the presence of the detected wireless tag and the wireless bridge location to a network. In some embodiments the method may further include accessing the communicated information by a user device connected to the network.

In some embodiments of the first aspect, the network may include at least one of a local wireless network, the Internet or the Internet accessed via a local wireless network. In some embodiments of the first aspect the method may further include receiving, at a server, a unique identifier of the wireless tag and location information indicative of the location of the wireless tag wherein the unique identifier and the location information is provided by the wireless bridge device configured to scan a defined area; querying a database for the unique identifier and writing the location information to a database item corresponding to the unique identifier; and sending the location information to the user device.

In some embodiments of the first aspect, the method may further include receiving a request from the user device wherein the request includes the unique identifier. In some embodiments of the first aspect, the unique identifier may be associated with a descriptive name and the user device may be configured to determine the unique identifier after receiving voice input specifying the descriptive name. In some embodiments of the first aspect the method may further include receiving, at a server, a ring request wherein the ring request includes a unique identifier of the wireless tag associated with an item attached to the wireless tag; updating, within a database, a property status corresponding to the item; receiving, from the wireless bridge, a request for the property status; sending, to the wireless bridge, information relating to the property status wherein the wireless bridge is configured to send, based upon the property status, a ring message to the wireless tag.

In some embodiments of the first aspect the method may further include performing a first wireless scan for wireless tag devices within a defined area; detecting, based upon the first wireless scan, at least a first device unique identifier corresponding to at least one wireless tag device; recording the first device unique identifier within a memory; performing a second wireless scan for wireless tag devices within the defined area; detecting, based upon the second wireless scan, one or more additional device unique identifiers; determining that none of the additional device unique identifiers correspond to the first device unique identifier; and sending a message indicating that the at least one wireless tag device has left the defined area. In some embodiments of the first aspect the method may further include performing a first wireless scan for wireless tag devices within a defined area; detecting, based upon the first wireless scan, at least a first device unique identifier corresponding to a first wireless tag device; recording the first device unique identifier within a memory; performing a second wireless scan for wireless tag devices within the defined area; detecting, based upon the second wireless scan, an additional device unique identifier; determining that the second device unique identifier does not correspond to the first device unique identifier; and sending a message indicating that a second wireless tag device has entered the defined area wherein the second wireless tag device corresponds to the second device unique identifier. In some embodiments of the first aspect the wireless device may communicate over a local area network, including Bluetooth, to the wireless bridge. In some embodiments of the first aspect the wireless bridge may be a gateway from the local area network to a broader area network, including Wi-Fi.

In a second aspect, a system may be provided including at least one wireless tag, and at least one wireless bridge acting as a gateway from the wireless tag to a network, the system configured to; assign wireless bridge location information; detect wireless tags within range by the wireless bridge; and communicate information including the presence of the detected wireless tag and the wireless bridge location to a network. In some aspects the system may further include and at least one user device connected to the network and be further configured to access the communicated information by a user device connected to the network.

In some embodiments of the second aspect, the network may include at least one of a local wireless network, the Internet or the Internet accessed via a local wireless network. In some embodiments of the second aspect, the system may further be configured to; receive, at a server, a unique identifier of the wireless tag and location information indicative of the location of the wireless tag wherein the unique identifier and the location information is provided by the wireless bridge configured to scan a defined area; query a database for the unique identifier and writing the location information to a database item corresponding to the unique identifier; and send the location information to the user device.

In some embodiments of the second aspect, the system may be further configured to receive a request from the user device wherein the request includes the unique identifier. In some embodiments of the second aspect, the unique identifier may be associated with a descriptive name and the user device is configured to determine the unique identifier after receiving voice input specifying the descriptive name.

In some embodiments of the second aspect, the system may be further configured to: receive at a server, a ring request wherein the ring request includes a unique identifier of the wireless tag associated with an item attached to the wireless tag; update within a database, a property status corresponding to the item; receive from the wireless bridge, a request for the property status; send to the wireless bridge, information relating to the property status wherein the wireless bridge is configured to send, based upon the property status, a ring message to the wireless tag. In some embodiments of the second aspect, the system may be further configured to: perform a first wireless scan for wireless tag devices within a defined area; detect, based upon the first wireless scan, at least a first device unique identifier corresponding to at least one wireless tag device; record the first device unique identifier within a memory; perform a second wireless scan for wireless tag devices within the defined area; detect, based upon the second wireless scan, one or more additional device unique identifiers; determine that none of the additional device unique identifiers correspond to the first device unique identifier; and send a message indicating that the at least one wireless tag device has left the defined area.

In some embodiments of the second aspect, the system may be further configured to: perform a first wireless scan for wireless tag devices within a defined area; detect, based upon the first wireless scan, at least a first device unique identifier corresponding to a first wireless tag device; record the first device unique identifier within a memory; perform a second wireless scan for wireless tag devices within the defined area; detect, based upon the second wireless scan, an additional device unique identifier; determine that the second device unique identifier does not correspond to the first device unique identifier; and send a message indicating that a second wireless tag device has entered the defined area wherein the second wireless tag device corresponds to the second device unique identifier.

In some embodiments of the second aspect, the wireless device may communicate over a local area network, including Bluetooth, to the wireless bridge. In some embodiments of the second aspect, the wireless bridge is a gateway from the local area network to a broader area network, including Wi-Fi.

In a third aspect, a system may be provided including a computing device communicatively connected with a network, the system configured to: receive wireless bridge location information from the network; receive wireless tag information from the network; query a database keyed by the tag information for the associated location information; and send the location information to the network. In a fourth aspect a system may be provided including a networking device communicatively connected with a network, the system configured to: receive communication from the network requesting a location of at least one wireless tag; detect the presence of zero or more wireless tags within range of the network device; and communicate information to the network, the information including the presence of zero or more detected wireless tags and a unique identifier associated with the networking device. In a fifth aspect a system may be provided including a computing device communicatively connected with a network, the system configured to: send desired tag information to the network; receive wireless bridge location information, associated with the desired tag, from the network; and display the associated wireless bridge location information.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 is a system block diagram of a system for tracking items within a defined area, according to an embodiment.

FIG. 2 is a block diagram of an exemplary implementation of a wireless bridge device.

FIG. 3 is a block diagram of an exemplary implementation of a wireless tag device.

FIG. 4 illustrates an exemplary table of a server database for a single tracked item.

FIG. 5 is a flowchart of an exemplary process through which location information of wireless tags is communicated via wireless bridge devices to a server.

FIG. 6 shows a flowchart of an exemplary process for using voice to query for item location information.

FIG. 7 illustrates an exemplary flowchart of a process for ringing items remotely.

FIG. 8 is a flowchart for an exemplary process for detecting when an item has left a defined area.

FIG. 9 is a flowchart for an exemplary process for detecting when an item has entered a defined area.

FIG. 10 illustrates an exemplary user interface for displaying location information of wireless tags.

FIG. 11 illustrates a form factor of an exemplary wireless tag.

FIG. 12 illustrates a form factor of an exemplary wireless bridge.

### DETAILED DESCRIPTION

Generally described, the disclosure relates to a system for locating wireless beacons within a defined area and having the location data available to users through a computer application. Consumers seek to locate items around the home and office everyday. While specific location data can be helpful, most consumers only seek location information to be specific to the room's name. The present disclosure details a system for tracking objects to specific locations such as rooms, and having this data readily accessible for consumers.

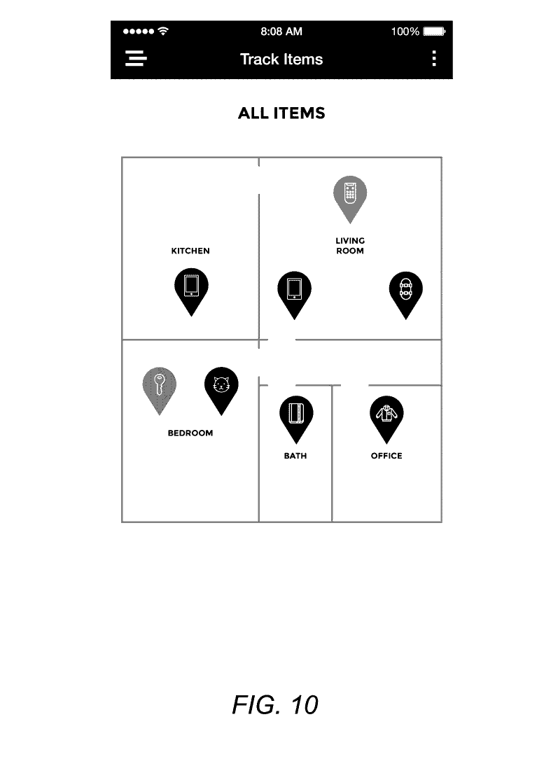

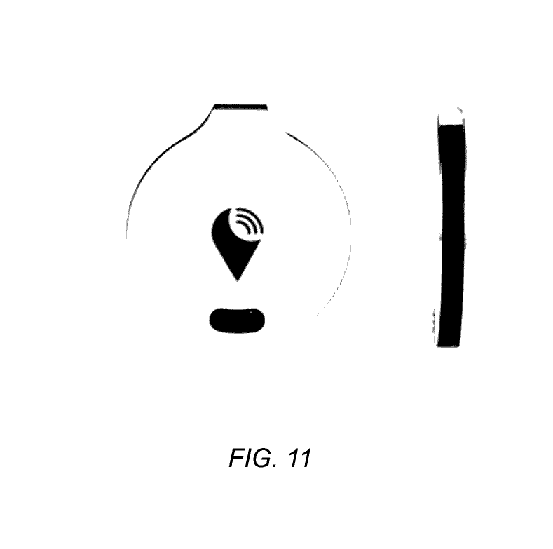

Examples and implementations described herein focus, for the purpose of illustration, on a system utilizing small wireless tags that can be attached to items such as TrackR Bluetooth enabled tracker devices. Examples of TrackR devices and operation are shown in FIGS. 10 and 11. The wireless tags emit a signal that uniquely identifies the individual item defined as the tag's unique identifier. The user utilizes a software application executing on a Personal Electronic Device (smartphone, tablet, PC etc.) or other computing device coupled to a network to associate the wireless tag's unique identifier with a database of items the user is interested in tracking. The tag can be attached to keys, wallet, purse, pet, children, furniture, documents, and more.

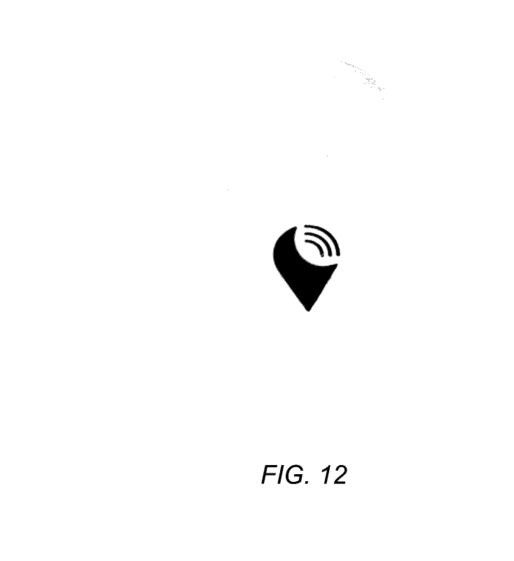

The system then utilizes wireless bridge devices that can communicate with the wireless tag using Bluetooth or any wireless communication protocol for a local area network. An example wireless bridge device is shown in FIG. 12. The wireless bridge acts as a gateway to a broader network, which may include directly or indirectly to the Internet, utilizing the home or office's Wi-Fi router, cellular network, or wired network line. The user can use software to assign the wireless bridge device unique information about the bridge including but not limited to name, location, GPS coordinates, user name, security information, accepted communication protocols, and other information. The wireless bridge can also receive this information directly from a network server or device, or other computing device, including in some embodiments an Internet server without user interaction. Wireless tag devices such as TrackR each have a unique identifier. The wireless bridge device will scan the area it's in for wireless tags and if a wireless tag is detected, the wireless bridge will detect the wireless tag's unique identifier. The wireless bridge will then send a communication packet to a server or other network entity with the wireless tag's unique identifier and other information such as the GPS coordinates and friendly location name the user assigned to the wireless bridge. When the wireless bridge detects a wireless tag, it can also be programmed to perform another action like attempt to connect to the wireless tag and write a value or send general information to devices on the network.

When the network entity (i.e. Internet server, local network entity, etc.) receives information from the wireless bridge, the network entity will parse the information for the wireless tag's unique identifier. When the network entity has parsed the unique identifier, the entity will query the database for registered items with the same unique identifier. If the database contains an item with the same unique identifier associated with it, the entity will parse the information it received from the wireless bridge for location information, GPS coordinates, and other important information for the user and will update the associated item's data in the database. This information can be downloaded to a computer application running on a PC or mobile device. The application may be configured to, for example, visually display a pin on a layout of a home or other premises corresponding to the location of the item. The application may be further configured to monitor when a wireless tag leaves or enters a given area (e.g., a particular room within a home). In addition, a user may also communicate with the wireless tags remotely via the software application.

Various aspects of the disclosure will now be described with regard to certain examples and embodiments, which are intended to illustrate but not limit the disclosure.

Some embodiments described herein provide for tracking of objects in consumer environments with low implementation costs, high accuracy, straightforward operation, and using compatible wireless technologies. Advantageously, this allows for widespread consumer use of wireless tracking.

Some embodiments described herein provide for tracking of objects within a home or office environment. Advantageously, this allows for quick and efficient location of objects within specific rooms or other indoor locations.

Examples of Object Tracking within Defined Areas

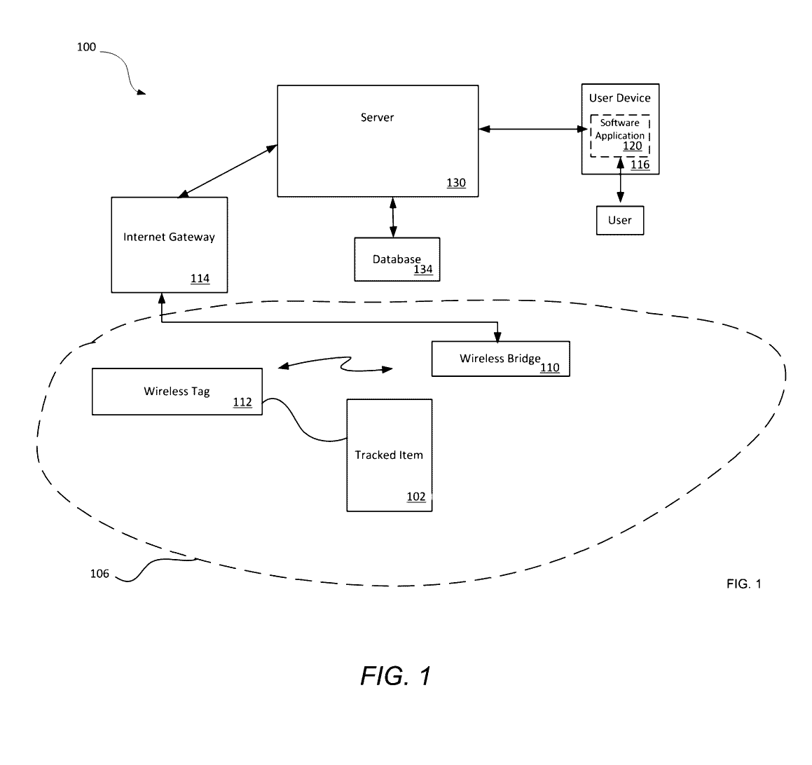

FIG. 1 is a system block diagram of a system 100 for tracking items, such as item 102, within a defined area 106, according to an embodiment. Referring FIG. 1, the system 100 includes at least one wireless bridge 110 in wireless communication with one or more wireless tags 112, each of which is attached to a particular tracked item 102. The wireless tags 112 may comprise, for example, TrackR Bluetooth enabled tracker devices. The wireless tags 112 each emit a signal that uniquely identifies the individual item defined as the tag's unique identifier. The user utilizes a software application to associate the wireless tag's unique identifier with a database of items the user is interested in tracking. The tag 112 can be attached to keys, wallet, purse, pet, children, furniture, documents, and more.

In one embodiment the wireless bridges 110 communicate with the wireless tags 112 using Bluetooth or any wireless communication protocol. Each wireless bridge 110 can also act as a gateway to a broader network. This may be a local network such as home or office WI-FI, or to the Internet utilizing an Internet gateway 114 in the form of, for example, a Wi-Fi router, cellular network, or wired network line. The following discussion will describe the case where the end destination network is the Internet, and an Internet server is the network entity utilized as part of the system. It is to be understood however that the Internet and server implementation is a likely and useful scenario. However, a local server or network device, running s suitable application may operate totally within any network. For instance any device connected to a home or office WI-FI network could be configured to query and upload/download wireless tag/wireless bridge data across the WI-FI network without ever accessing the Internet. Thus in all of the description below, the actions attributed to an Internet server could be accomplished by a server or other network entity on any network accessed by the wireless bridge. A user device 116 may execute a software application 120 configured to assign each wireless bridge device 110 unique information about the bridge including but not limited to name, location, GPS coordinates, user name, security information, accepted communication protocols, and other information.

For the Internet example, each wireless bridge 110 can also receive this information directly from an Internet server 130 without user interaction. Wireless tag devices 112 such as TrackR each have a unique identifier. The wireless bridge device 110 will scan the defined area 106 for wireless tags 112 and if a wireless tag 112 is detected, the wireless bridge 110 will detect the unique identifier of the wireless tag 112. The wireless bridge 110 will then send a communication packet to an Internet server with this unique identifier and other information such as the GPS coordinates and friendly location name the user assigned to the wireless bridge 110. When the wireless bridge 110 detects a wireless tag 112, it can also be programmed to perform another action like attempt to connect to the wireless tag 112, write a value to the wireless tag 112, or send general information to the Internet server 130.

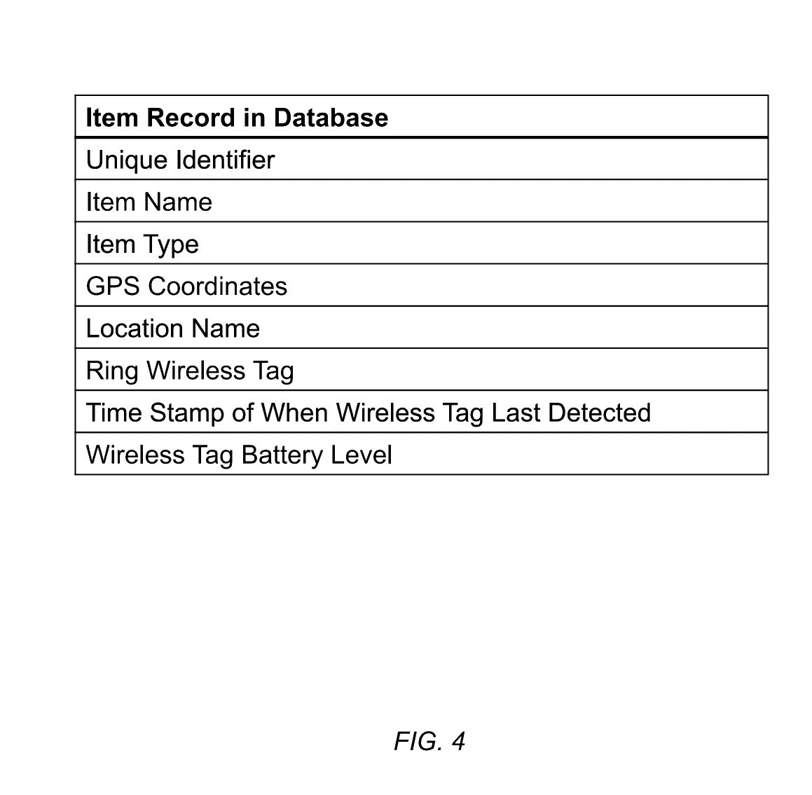

When the Internet server 130 receives information from a wireless bridge 110, the server 130 will parse the information for the unique identifier of a wireless tag 112. When the server 130 has parsed the unique identifier, the server 130 will query a database 134 for registered items with the same unique identifier. See FIG. 4. If the database 134 contains an item with the same unique identifier associated with it, the server 130 will parse the information it received from the wireless bridge 110 for location information, GPS coordinates, and other important information for the user and will update the associated item's data in the database 134. This information can be downloaded to the software application 120 running on the user device 116 (e.g., a PC or mobile device).

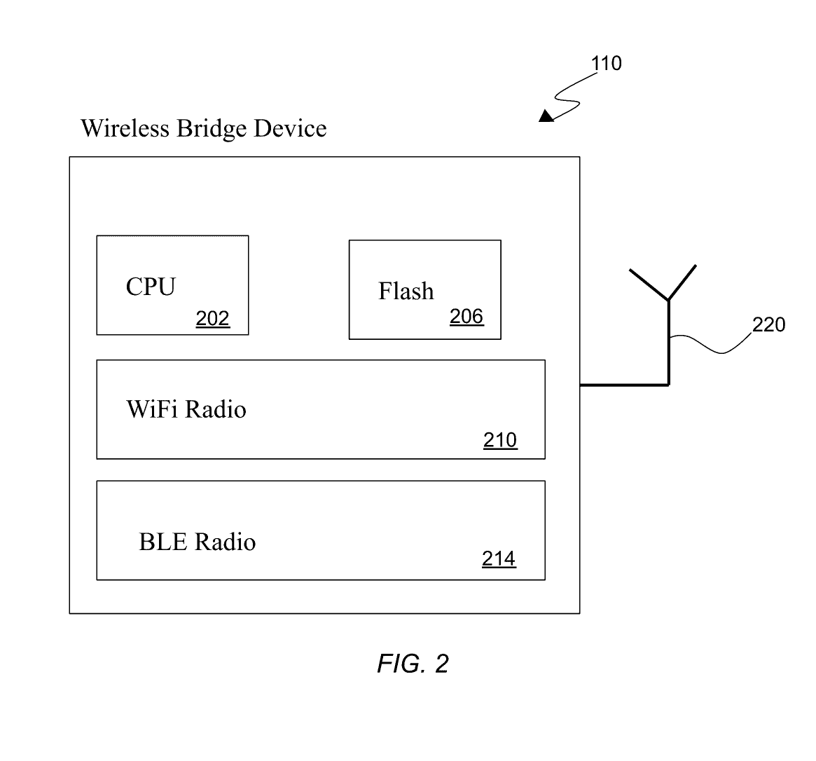

Attention is directed to FIG. 2, which is a block diagram of an exemplary implementation of a wireless bridge device 110. As shown, the wireless bridge device 110 may include a processor 202, Flash memory 206, a Wi-Fi radio 210 and a Bluetooth Low Energy (BLE) radio 214. The bridge device 110 may also include one or more antennas 220.

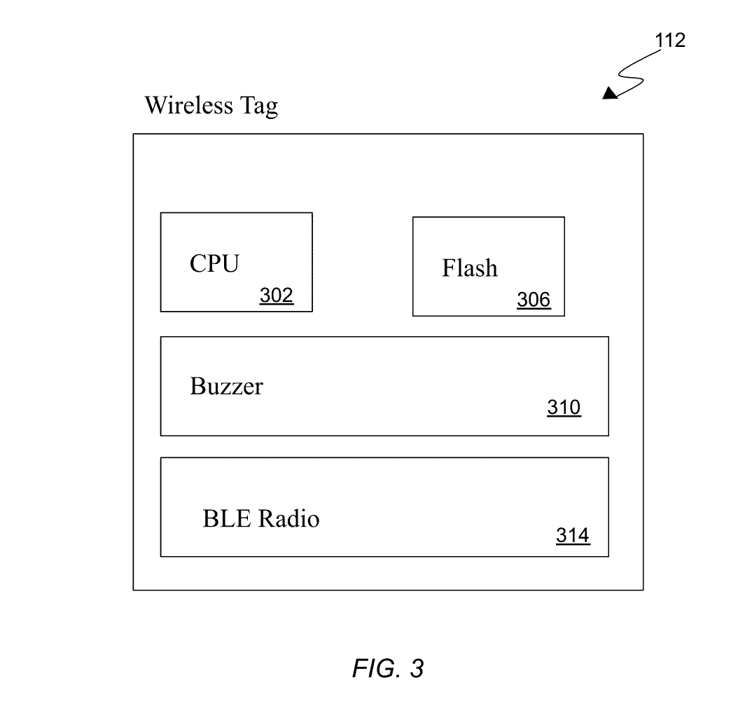

Turning now to FIG. 3, a block diagram is provided of an exemplary implementation of a wireless tag device 112. As shown, the wireless tag device 112 may include a processor 302, Flash memory 306, a buzzer 310 or other audio speaker, and a Bluetooth Low Energy (BLE) radio 314.

Referring again to FIG. 1, the software application 120 can enable the user to, for example, draw a layout of their home and assign room names to the layout corresponding to the location names of wireless bridge devices 110. If an item in the database 134 is associated with a location name, the app 120 can visually display a pin on the layout corresponding to the location.

In another implementation, the user is able to access location data through a voice service such as Amazon Alexa, Apple Homekit, or Google Now. In one embodiment the user device 116 is a voice-enabled device, such as a smartphone, configured to receive a voice command from a user. A 3^{rd} party voice service will translate the voice recording to text and return the text to the software 120 running on the voice enabled device 116. The software 120 will parse the command for item name keywords such as “keys” or “wallet”. The software 120 running on the voice enabled device 116 will query the database 134 for the item's friendly name (e.g., “living room”). Once the item has been found, the software 134 will extract the location name written by the wireless bridge device 110 and send this information back to the 3^{rd} party voice service to compile an answer such as “Your keys are in the living room”.

For example, consider the case in which a wireless bridge 110 has the location name “living room” associated with it. When this wireless bridge 110 detects a wireless tag 112, it sends the unique identifier of the tag 112 to the server 130 along with the location name, “living room”. Once the server 130 receives this communication, it will scan its database 134 for the unique identifier and update the associated item's data table with the new location “living room”. See FIG. 4. So when the user utilizes the software application 120 to see where the item is located, the software application 120 will be able to display “living room” to the user.

The user can also communicate with the wireless tags 112 remotely via the software application 120. The software application 120 is able to send an http command such as a HTTP POST to the server 130 containing a message and the unique identifier of the targeted wireless tag 112. The server 130 will then query its database 134 for the item with the unique identifier associated with the message and update that row in the database with the message value. The value can be read by a wireless bridge device 110 when the wireless bridge device 110 detects a wireless tag 112 with the unique identifier associated with it. The wireless bridge 110 will commence an HTTP GET or other HTTP command and will receive the message associated with the unique identifier of the wireless tag 112. Based on the message, the wireless bridge 110 may perform one or more of several potential actions. One of these actions could be to, for example, activate the buzzer 310 on the wireless tag device 112 (e.g., like the buzzer on a TrackR device). Once the wireless bridge device 110 receives the message data from the server 130, the bridge 110 will utilize, for example, the Bluetooth Low Energy radio 214 to connect to the wireless tag 112 associated with the unique identifier. Once the wireless tag 112 has been connected to, the wireless bridge 110 will issue a command to the wireless tag 112 that will cause the buzzer 310 of the wireless tag 112 to activate. After a pre-specified amount of time, the wireless bridge 110 will issue a command to silence the buzzer 310 of the wireless tag 112 and will disconnect. Any message can be sent to the wireless tag 112 or read from the wireless tag 112 such as reading the wireless tag's battery information.

The system can also monitor when a wireless tag 112 leaves an area of enters an area. Specifically, in one embodiment the wireless bridge device 110 will periodically scan for wireless tags 112 at a predetermined interval. When the wireless tag 112 is detected, the timestamp of when the wireless tag 112 that was detected is saved locally in the wireless bridge device's flash memory 206 along with the wireless tag's unique identifier. During the next scan, the wireless bridge device 110 will compare the unique identifiers of which wireless tags 112 were detected versus the wireless identifiers of the wireless tags 112 that were detected in the previous scan. If one of the wireless tag unique identifiers that were present in the last scan is not detected, the wireless bridge device 110 will send a message to the server 130 along with the wireless tag unique identifier. The wireless bridge device 110 can also detect if a new wireless tag's unique identifier is present that was not in the previous scan and send a message to the server 130 along with the wireless tag's unique identifier. Once the server 130 has received the message, the server 130 can issue a notification to the user on their user device 116 to alert them that an item has entered or left the defined area 106.

Using this same system, the server 130, database 134 and wireless bridge(s) 110 can cooperate to keep a record of when an item enters and leaves the defined area(s) 106. With multiple wireless bridge devices 110, a wireless tag's location from room to room can be recorded and queried by the user on their user device 116.

Example Methods for Object Tracking within a Defined Area

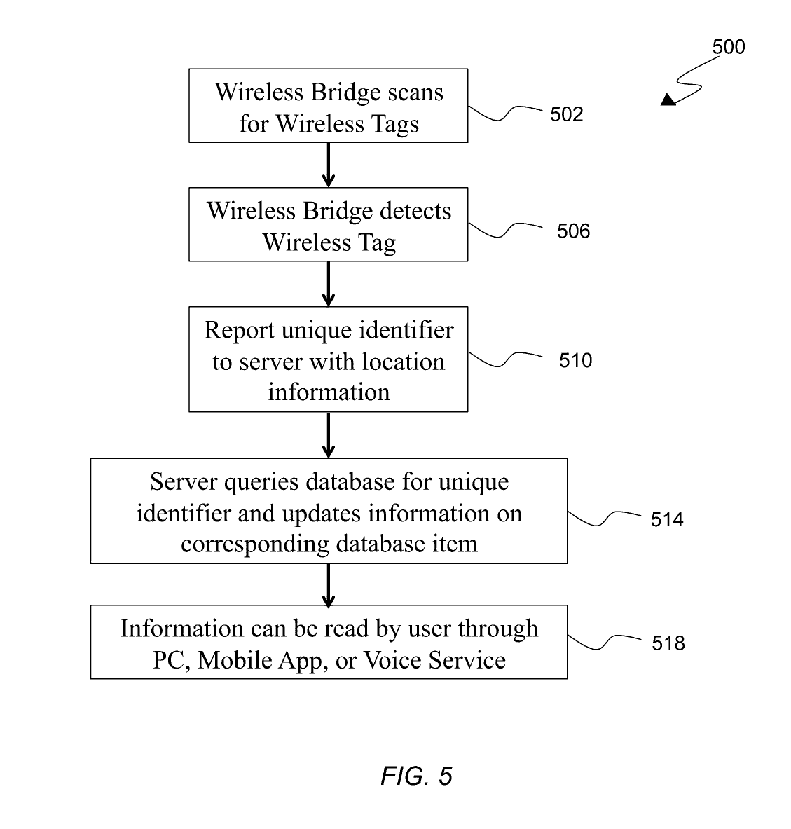

Attention is now directed to FIG. 5, which is a flowchart of an exemplary method 500 through which location information of wireless tags 112 are communicated via wireless bridge devices 110 to server 130. As shown, the wireless bridge 110 initially scans for wireless tags 112 located within its defined area 106 (stage 502). The wireless bridge 110 may then detect a wireless tag 112 (stage 506). Next, the wireless bridge 110 may report the unique identifier of the detected wireless tag 112 to the server 130 with location information indicative of the location of the wireless tag 112 (stage 510). The server 130 may then query the database 134 for the unique identifier and updates information on corresponding database item (stage 514). Information may then be provided to user through an application or voice service supported by the user device 116 (stage 118).

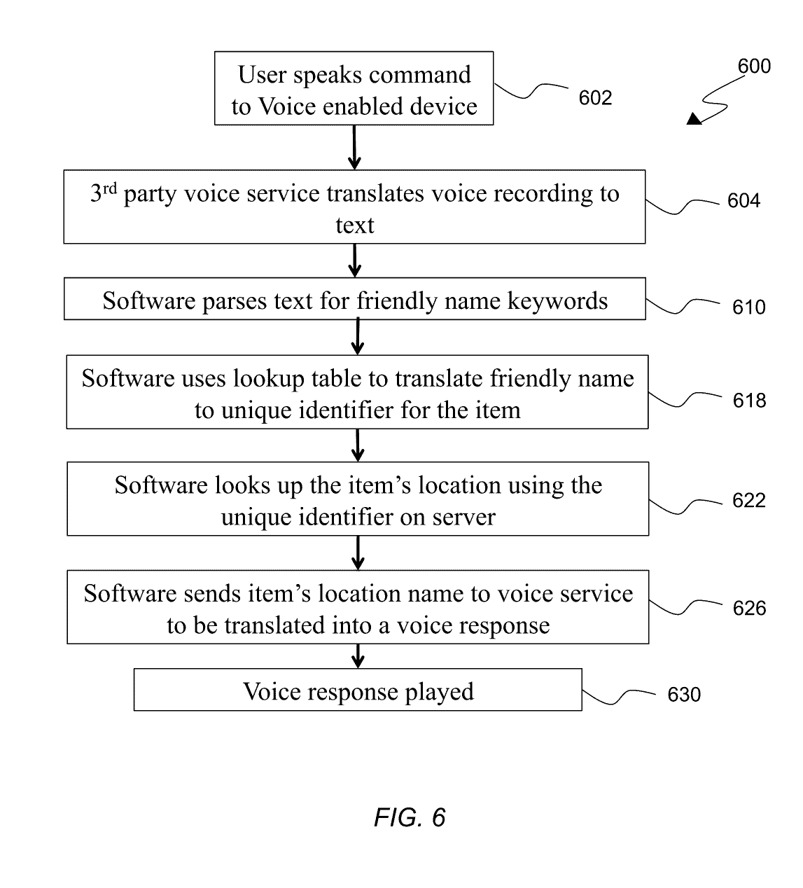

Referring now to FIG. 6, there is shown a flowchart of an exemplary method 600 for using voice to query for item location information within, for example, the context of the system 100 of FIG. 1. As shown, the process is initiated by a user speaking a command to a voice-enabled device such as the user device 116 when configured to support a 3rd voice service (stage 602). The command is recorded and the 3^{rd} party voice service translates the resulting voice recording to text (stage 606). The software application 120 or other mobile application then parses the text for friendly name keywords (stage 610) and uses a lookup table to translate the friendly name to the unique identifier for the item (stage 618). Next, the software application 120 or other mobile application initially a procedure to lookup using, for example, one or more database tables stored within the database 134, the item's location using the unique identifier (stage 622). Once received at the user device 116, the item's location name may be provided to the voice service to be translated into a voice response (stage 626). The voice response may then be rendered by the user device 116 (stage 630).

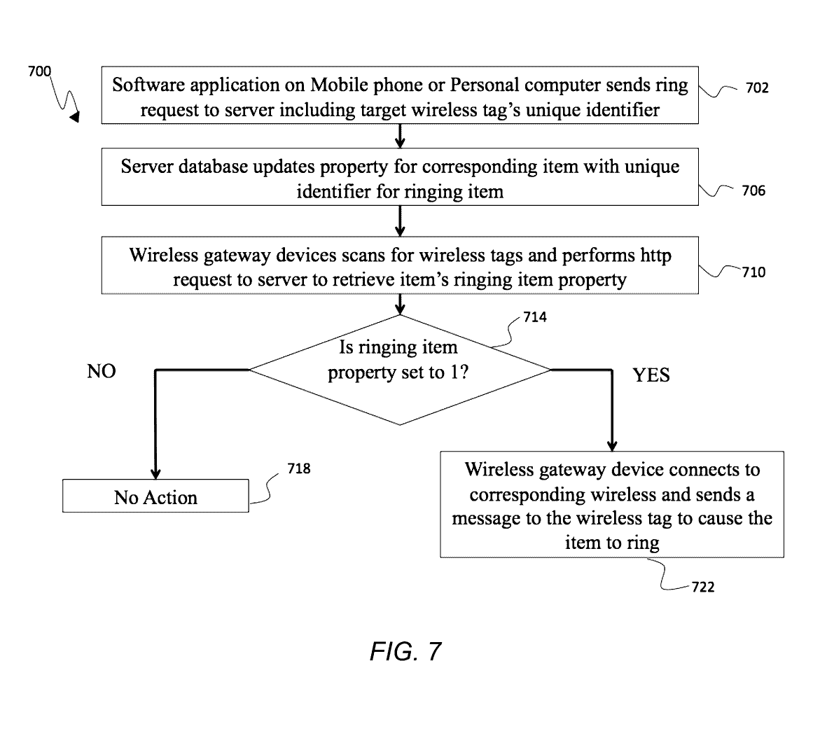

Turning to FIG. 7, there is illustrated an exemplary flowchart of a method 700 for ringing items remotely. As shown, the software application 120 or other mobile application executed by the user device 116 sends a ring request to the server 130 (stage 702). The request may include the target wireless tag's unique identifier. The server 130 updates, within the database 134, the property for the item having a unique identifier corresponding to that of the ringing item (stage 706). A wireless gateway device may then scan for wireless tags and perform an http request to server 130 to retrieve the item's ringing item property (stage 710). Next it is determined if the ringing item property is set to a predefined value, e.g., set to 1 (stage 714). If not, no action is taken (stage 718). If so, in one embodiment the wireless gateway device connects to the corresponding wireless tag or wireless bridge and sends a message to the wireless tag to cause the item to ring (stage 722).

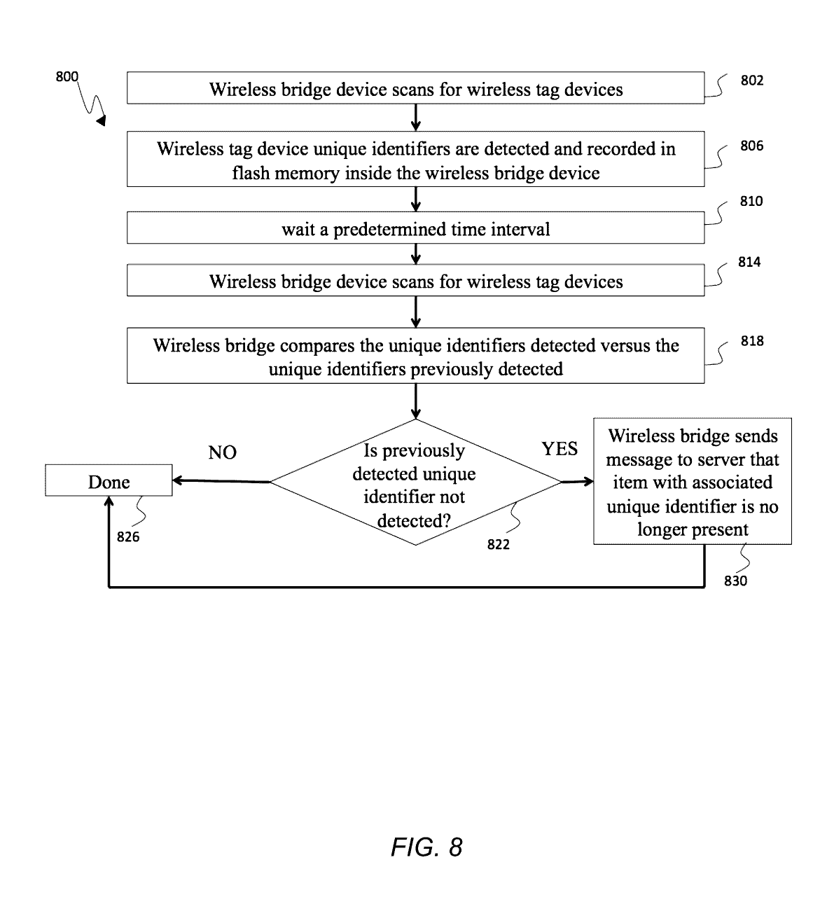

Attention is now turned to FIG. 8, which is a flowchart for an exemplary method 800 for detecting when an item has left a defined area. The process is initiated when a wireless bridge device 110 scans for wireless tag devices 112 within a defined area 106 (stage 802). Wireless tag device unique identifiers are then detected by the bridge device 110 and recorded in flash memory 206 of the wireless bridge device 110 (stage 806). After waiting a predetermined time interval (stage 810), the wireless bridge device 110 scans for wireless tag devices 112 (stage 814). The wireless bridge device 110 then compares the unique identifiers detected to the unique identifiers previously detected (stage 818). It is then determined by the wireless bridge device 110 whether any previously detected unique identifier are no longer detected (stage 822). If not, then no items have left the defined area and no further action is taken (stage 826). If so, the wireless bridge 110 sends a message to the server 130 that the item with the associated unique identifier is no longer present within the defined area (stage 830).

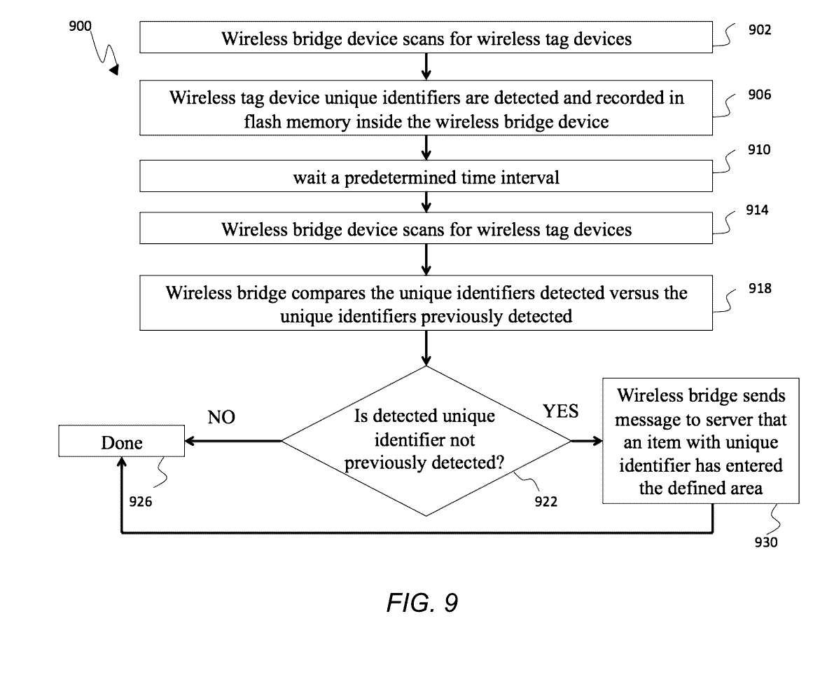

Attention is now turned to FIG. 9, which is a flowchart for an exemplary process 900 for detecting when an item has entered a defined area. The process is initiated when a wireless bridge device 110 scans for wireless tag devices 112 within a defined area 106 (stage 902). Wireless tag device unique identifiers are then detected by the bridge device 110 and recorded in flash memory 206 of the wireless bridge device 110 (stage 906). After waiting a predetermined time interval (stage 910), the wireless bridge device 110 scans for wireless tag devices 112 (stage 914). The wireless bridge device 110 then compares the unique identifiers detected to the unique identifiers previously detected (stage 918). It is then determined by the wireless bridge device 110 whether any currently detected unique identifier was not previously detected (stage 922). If not, then no items have entered the defined area since it was previously scanned and no further action is taken (stage 926). If so, the wireless bridge 110 sends a message to the server 130 that the item with the detected unique identifier has entered the defined area (stage 930).

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

As used in this specification, a module can be, for example, any assembly and/or set of operatively-coupled electrical components associated with performing a specific function(s), and can include, for example, a memory, a processor, electrical traces, optical connectors, software (that is stored in memory and/or executing in hardware) and/or the like.

Some embodiments of the items tracking techniques described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A method, comprising;
assigning a wireless bridge location information;
detecting wireless tags within range by the wireless bridge; and,
communicating information including the presence of the detected wireless tag and the wireless bridge location to a network; and,

2. The method of claim 1 further comprising accessing the communicated information by a user device connected to the network.

3. The method of claim 2 wherein the network includes at least one of a local wireless network, the Internet or the Internet accessed via a local wireless network.

4. The method of claim 3, comprising;
receiving, at a server, a unique identifier of the wireless tag and location information indicative of the location of the wireless tag wherein the unique identifier and the location information is provided by the wireless bridge device configured to scan a defined area;
querying a database for the unique identifier and writing the location information to a database item corresponding to the unique identifier; and
sending the location information to the user device.

5. The method of claim 4 further including receiving a request from the user device wherein the request includes the unique identifier.

6. The method of claim 5 wherein the unique identifier is associated with a descriptive name and the user device is configured to determine the unique identifier after receiving voice input specifying the descriptive name.

7. The method of claim 3, comprising:
receiving, at a server, a ring request wherein the ring request includes a unique identifier of the wireless tag associated with an item attached to the wireless tag;
updating, within a database, a property status corresponding to the item;
receiving, from the wireless bridge, a request for the property status;
sending, to the wireless bridge, information relating to the property status wherein the wireless bridge is configured to send, based upon the property status, a ring message to the wireless tag.

8. The method of claim 3, comprising:
performing a first wireless scan for wireless tag devices within a defined area;
detecting, based upon the first wireless scan, at least a first device unique identifier corresponding to at least one wireless tag device;
recording the first device unique identifier within a memory;
performing a second wireless scan for wireless tag devices within the defined area;
detecting, based upon the second wireless scan, one or more additional device unique identifiers;
determining that none of the additional device unique identifiers correspond to the first device unique identifier; and
sending a message indicating that the at least one wireless tag device has left the defined area.

9. The method of claim 3 comprising:
performing a first wireless scan for wireless tag devices within a defined area;
detecting, based upon the first wireless scan, at least a first device unique identifier corresponding to a first wireless tag device;
recording the first device unique identifier within a memory;
performing a second wireless scan for wireless tag devices within the defined area;
detecting, based upon the second wireless scan, an additional device unique identifier;
determining that the second device unique identifier does not correspond to the first device unique identifier; and
sending a message indicating that a second wireless tag device has entered the defined area wherein the second wireless tag device corresponds to the second device unique identifier.

10. The method of claim 1 wherein the wireless device communicated over a local area network, including Bluetooth, to the wireless bridge.

11. The method of claim 10 wherein the wireless bridge is a gateway from the local area network to a broader area network, including Wi-Fi.

12. A system, comprising at least one wireless tag, and at least one wireless bridge acting as a gateway from the wireless tag to a network, the system configured to;
assign wireless bridge location information;
detect wireless tags within range by the wireless bridge;
communicate information including the presence of the detected wireless tag and the wireless bridge location to a network; and,

13. The system of claim 12 further comprising a user device and further configured to access the communicated information by the user device connected to the network.

14. The system of claim 13 wherein the network includes at least one of a local wireless network, the Internet or the Internet accessed via a local wireless network.

15. The system of claim 14, further configured to;
receive, at a server, a unique identifier of the wireless tag and location information indicative of the location of the wireless tag wherein the unique identifier and the location information is provided by the wireless bridge configured to scan a defined area;
query a database for the unique identifier and writing the location information to a database item corresponding to the unique identifier; and
send the location information to a user device.

16. The system of claim 14 further configured to receive a request from the user device wherein the request includes the unique identifier.

17. The system of claim 16 wherein the unique identifier is associated with a descriptive name and the user device is configured to determine the unique identifier after receiving voice input specifying the descriptive name.

18. The system of claim 14, further configured to:
receive at a server, a ring request wherein the ring request includes a unique identifier of the wireless tag associated with an item attached to the wireless tag;
update within a database, a property status corresponding to the item;
receive from the wireless bridge, a request for the property status;
send to the wireless bridge, information relating to the property status wherein the wireless bridge is configured to send, based upon the property status, a ring message to the wireless tag.

19. The system of claim 14, further configured to:
perform a first wireless scan for wireless tag devices within a defined area;
detect, based upon the first wireless scan, at least a first device unique identifier corresponding to at least one wireless tag device;
record the first device unique identifier within a memory;
perform a second wireless scan for wireless tag devices within the defined area;
detect, based upon the second wireless scan, one or more additional device unique identifiers;
determine that none of the additional device unique identifiers correspond to the first device unique identifier; and
send a message indicating that the at least one wireless tag device has left the defined area.

20. The system of claim 114 further configured to:
perform a first wireless scan for wireless tag devices within a defined area;
detect, based upon the first wireless scan, at least a first device unique identifier corresponding to a first wireless tag device;
record the first device unique identifier within a memory;
perform a second wireless scan for wireless tag devices within the defined area;
detect, based upon the second wireless scan, an additional device unique identifier;
determine that the second device unique identifier does not correspond to the first device unique identifier; and
send a message indicating that a second wireless tag device has entered the defined area wherein the second wireless tag device corresponds to the second device unique identifier.

21. The system of claim 12 wherein the wireless device communicated over a local area network, including Bluetooth, to the wireless bridge.

22. The system of claim 21 wherein the wireless bridge is a gateway from the local area network to a broader area network, including Wi-Fi.

23. A system comprising a computing device communicatively connected with a network, the system configured to:
receive wireless bridge location information from the network;
receive wireless tag information from the network;
query a database keyed by the tag information for the associated location information; and
send the location information to the network.

24. A system comprising a networking device communicatively connected with a network, the system configured to:
receive communication from the network requesting a location of at least one wireless tag;
detect the presence of zero or more wireless tags within range of the network device; and
communicate information to the network, the information including the presence of zero or more detected wireless tags and a unique identifier associated with the networking device.

25. A system comprising a computing device communicatively connected with a network, the system configured to:
send desired tag information to the network;
receive wireless bridge location information, associated with the desired tag, from the network; and
display the associated wireless bridge location information.
